(19) United States
(12) Patent Application Publication
(10) Pub. No.: US 2007/0050468 A1
(43) Pub. Date: Mar. 1, 2007

(54) Reality context menu (RCM)

(75) Inventor: Amir Gazit, Tel-Mond (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 11/199,261

(22) Filed: Aug. 9, 2005

(51) Int. Cl. G06F 15/16

(52) U.S. Cl. 709/217

(57) ABSTRACT

A system and a method providing a user with a plurality of services related to physical objects. A mobile device, which detects a physical object, is provided. The physical object is detected based on recognizing an object identifier. In addition, a number of external service providers is also provided. Each of these service providers offers one or more services with respect to the detected physical object. A service directory server registers the external service providers to generate a list of the available services for the detected physical object.

### BACKGROUND OF THE INVENTION

1. Field of the Invention

A system and a method consistent with the present invention broadly relates to dynamic and context based menus using sensors, context awareness, and augmented reality. More particularly, the present invention is consistent with providing a system and a method relating to dynamic and context based menus of real physical objects using a mobile device.

2. Description of the Related Art

Dynamic and context based menus are beginning to gain popularity in today's world. For example, U.S. Publication No. 2004/0066931 to Tankhiwale, published Apr. 8, 2004, the disclosure of which is incorporated herein by reference, discloses dynamic feature and function availability for software PBX (private branch exchange), e.g., a function “conference call” will not be available until more than one incoming call is made to the same telephone. Another dynamic menu is disclosed in U.S. Pat. No. 6,462,760 to Cox, Jr., et al., which is incorporated herein by reference, and which discloses associating an icon with a plurality of operations that change in response to user input. That is, an icon's visual appearance is used to associate the icon with a particular operation. In response to input from a user, the icon's appearance changes to indicate that the icon is now associated with an alternative operation. Thus, a Graphical User Interface (GUI) for operating a computer system can use a single icon to represent and provide access to a plurality of operations that otherwise may require several icons. None of these techniques, however, relate to real-life objects. That is, in the related art, these dynamic menus are not for the physical, tangible objects but rather for user interfaces.

For the real-life objects, some techniques for gathering information about these objects are available. For example, in U.S. Pat. No. 6,778,683, incorporated herein by reference, FEDERAL EXPRESS™ discloses a system, where packages are randomly placed on a conveyor belt, with their labels facing a two-camera subassembly. As the conveyor belt moves, the two-camera subassembly continuously takes images of the belt underneath the overhead camera. The design of the camera permits it to take a high resolution image of a non-singulated, unjustified package flow. A digital image of the packages within the field of view of the camera is then transferred to the processing system for analysis. The analysis process utilizes conventional Optical Character Recognition (OCR) and Intelligent Character Recognition (ICR) techniques to evaluate the information written on the package label, i.e., to determine the destination address of the package.

Other techniques for collecting information about a physical object are also available. For example, WAL-MART™ uses bar codes to determine the price of real-life objects. These solutions are customized solutions for a specific service, i.e., the user first accesses the service (Fed-Ex or Wal-Mart) and from there, the object.

Accordingly, these solutions allow for a particular physical object to be associated only with a certain service and not open to other services. Also, in most cases, these solutions associate the service with the way the object is identified (e.g., Wal-Mart using barcodes). In the conventional techniques, there is no generic architecture that will put the object in the center. In other words, the conventional techniques do not permit the user to ask “what can I do with this object?” No open architectures is available that would allow a system to openly add new object types, new identification methods, and new services for the new or old objects in the system.

Moreover, there are no known methods that would provide a service to allow a mobile device to control a physical object. For example, there are no known methods that would allow the mobile device to identify a physical object and to then download information for control of the physical object to this device. In other words, no methods are known that would allow a mobile device to become, on the fly, a remote control of an identified physical object.

### SUMMARY OF THE INVENTION

An objective of the present invention, among other objectives which will become apparent from reading the description herein, is to provide a reality context menu for real-life objects to overcome the above-mentioned problems by placing the physical object in the center and allowing the user, by manipulating the context menu in a remote device, to obtain information, activate, and/or control the physical object.

Another objective, among other objectives, is to permit adding new object types, new identification methods, and new services for the new or old physical objects.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

It is an aspect of the present invention to provide a system and a method for providing services related to a physical object. In the system and method, a user selects a physical object from a number of physical objects, and the identification or an identifier of the physical object is detected via a mobile device. Based on the detected identification by the mobile device, the mobile device queries directory server for a list of available services for the selected physical object. The available services are provided by various external service providers. The directory server, based on the detected identification, searches for available services for the selected physical object registered with the directory server. In this system and method, the directory server generates a reality context menu, which lists available services for the physical object found by the directory server, and the generated reality context menu is provided to the user via the mobile device.

### BRIEF DESCRIPTION OF THE DRAWINGS

The above aspects and other advantages of the present invention will become more apparent when taken in conjunction with the below descriptions of various illustrative, non-limiting embodiments thereof with reference to the accompanying drawings, in which:

FIG. 1 illustrates the components of an exemplary reality, context menu service according to an exemplary, non-limiting embodiment of the present invention.

FIG. 2 shows an exemplary flow diagram of a registration process of the external service providers according to the illustrative embodiment of the present invention.

FIG. 3 illustrates an exemplary flow diagram of the process of a user obtaining a desired service with respect to the physical object in accordance with the illustrative embodiment of the present invention.

FIGS. 4A and 4B illustrates exemplary flow charts showing variations in implementing a service selected by the user according to the illustrative embodiment of the present invention.

FIG. 5 shows a flow chart illustrating the process flow of RCM service for a book in accordance with another exemplary, non-limiting embodiment of the present invention.

FIG. 6 illustrates an exemplary reality context menu in accordance with an exemplary, non-limiting embodiment of the present invention.

### DETAILED DESCRIPTION OF THE ILLUSTRATIVE, NON-LIMITING EMBODIMENTS

The present invention will now be described in detail by describing various illustrative, non-limiting embodiments thereof with reference to the accompanying drawings. The present invention may, however, be embodied in many different forms and should not be construed as being limited to the illustrative embodiments set forth herein. Rather, the embodiments are provided so that this disclosure will be thorough and complete, and will fully convey the concept of the present invention to those skilled in the art. The claims should be consulted to ascertain the true scope of the present invention.

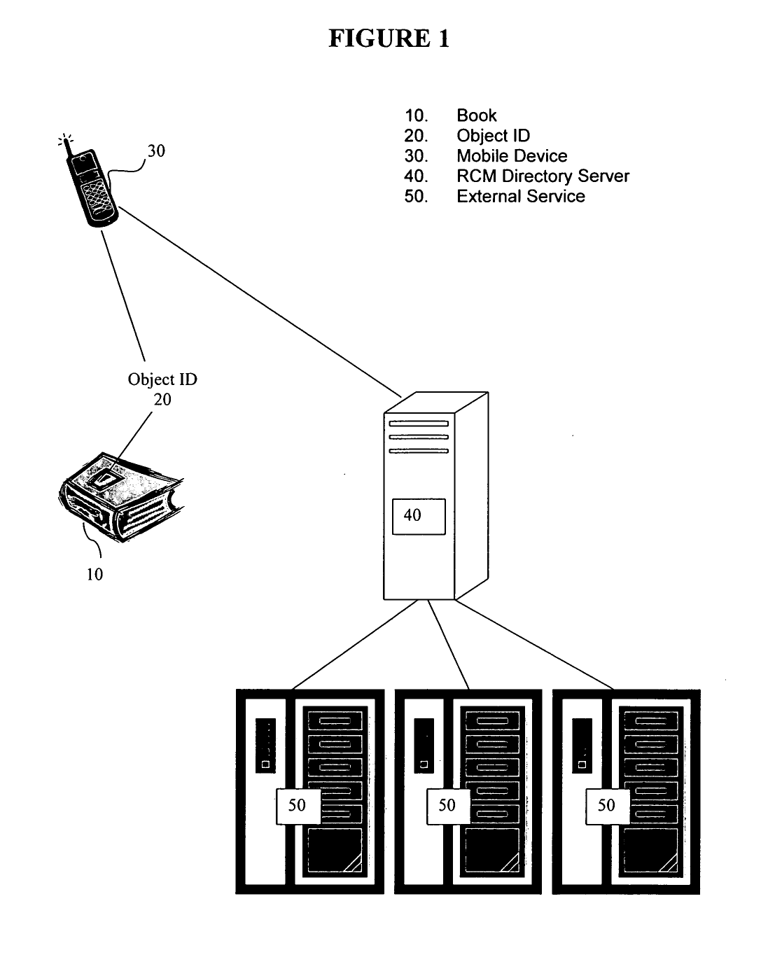

This illustrative, non-limiting embodiment of the present invention relates to a reality, context menu (RCM) service. FIG. 1 depicts the components of an exemplary RCM service. In particular, the RCM service has a physical object 10. This physical object 10 is any real-life object, creature, or a tangible item. For example, a real-life object can be an electrical appliance, a book, a grocery item, an exhibition item, a car, an animal, and so on. The only requirement for the physical object 10 is to be able to contain some kind of identification such as a microchip or a tag. The identification can be provided within the device, externally attached, or in any other way known in the art or developed in the future.

As depicted in FIG. 1, the physical object 10 has an identification, object ID 20. The object ID 20 is the actual number or any other index that identifies the object (instance or type). The object ID can be a catalogue number, an address, an index, an International Standard Book number (ISBN), an Internet Protocol (IP) address, a Uniform Address Locator (URL), a Mobile Station Integrated Services Digital Network number (MSISDN), some other numbering plan or any other symbols, numbers, characters and so on. Any semantics for the object ID 20, currently known in the art or future discovered, are within the scope of the invention.

For example, the object ID 20 can be a specific instance of the object such as a license plate. Alternatively, the object ID 20 can be a type of object such as one or more alphanumeric characters that identify the physical object 10 as being a specific car model. The physical object 10 can have several object IDs to describe, for example, different dimensions of the object such as one for the object instance and one for the object type. Other descriptions of the physical object 10 are within the scope of the present invention. The object ID 20 can be used to identify one or more attributes of the physical object 10. The physical object 10 may have one or more object IDs 20. It should be noted that the object ID 20 will identify both the object serial ID and the catalogue name. For example, a book may have an object ID that specifies that the object ID is an ISBN number and the book's specific ISBN number, a TV may have an object ID that specifies that the object ID is a Sony model number and the TV's specific model number. In other words, the object ID 20 may also specify the type of number being used to describe the physical object.

To identify the physical object 10, various detection methods could be used. A detection method physically marks the object 10 with an object ID 20 and detects the marked object ID 20. For example, the object ID 20 could be in a barcode, where a barcode reader reads the object ID 20 encoded in the barcode. Other means of identification are also within the scope of the present invention. Within the scope of the invention are identification methods such as an optical character recognition (OCR), radio frequency identification (RFID), and many others known to the one of ordinary skill in the art or developed at a future date.

For example, the object ID 20 could be provided: on a tag, which is located in or on a book, on a label on a T-shirt, on a microchip placed on or inside a refrigerator. A specific object ID for a particular physical object 10 can be marked using several detection methods for reading flexibility. By way of an example, a physical object 10 having a specific object ID can have the specific object ID marked with a barcode and RFID such that both the Barcode reader and the RFID reader will be able to identify the specific object ID. By way of another example, the specific object ID could be encoded on a tag and a microchip so that two detection methods can identify the specific object ID 20.

For the user to acquire information about the physical object 10, a mobile device 30 is provided. The mobile device 30 will read the object ID 20 by any available method. For example, a mobile device 30 may be a mobile phone with a camera. If the mobile device 30 is a mobile phone with a camera, the user may then take a picture of the object ID 20 for the identification of the physical object 10. The mobile device 30 may recognize the object ID 20 using any one of the following techniques: OCR, Barcode, Wireless Fidelity (WiFi) protocol, Bluetooth, and Radio Frequency Identifier (RFID). Alternatively, the user can simply type the object ID 20 into the mobile device 30. The above-provided examples of the object IDs 20 and the detection methods are provided by way of an example only, to further the understanding of the present invention and not by way of a limitation. In the present invention, any indexing methods and any detection methods, known to one of ordinary skill in the art or future developed, could be used.

Information for each object ID 20 is stored in the RCM directory server 40. This RCM directory server 40 includes an entry per each object ID 20. The RCM directory server 40 is not necessarily a single hardware server and can be distributed in a network or have replications thereof (including in the mobile device 30 for caching). Moreover, the RCM service includes a number of external services, depicted in FIG. 1 as 50, 50, and 50. Each external service 50 stores one or more possible services for the physical objects. The services are linked to the physical objects using an object ID 20.

Each external service 50 will register services it can provide with the RCM directory server 40. These services will be associated with a specific object ID 20. The registration can include the service identification and the available commands. The registration should also allow adding of the information that will be presented to the user e.g., the service name and the command names. The RCM directory server 40 can apply any directory architecture, e.g., Web Service Description Language (WSDL) and any command activation methods, e.g., URL.

The external service 50 can be any application providing a service for a particular physical object 10. The external service 50 can include control and activation of the physical object 10. For example, if a physical object 10 is a type of a TV set and is identified as this type via the object ID 20, the Infra-Red commands are downloaded from the RCM directory server 40 to the mobile device 30. These downloaded commands will make the mobile device 30 a remote control of this TV set (physical object 10). That is, the user using the mobile device 30 could turn on the TV set or change a channel and so on. Moreover, using the mobile device 30, the user could execute a number of commands such as reading a meter of the physical device 10.

Alternatively or in addition, the external services 50, 50, 50, may directly (not via the mobile device 30) execute commands that will turn on this TV set (physical object 10) or the external services 50, 50, 50, may directly read a meter of the physical device 10. That is, instead of providing the commands to the mobile device 30, the external services 50, 50, 50, will directly execute the commands indicated on the object ID 20.

The external services 50, 50, 50 may also or in the alternative provide information regarding the physical object 10 from an external source, e.g., the object's manual or list price. Likewise, the external service 50 may provide commands to execute a transaction related to the physical object 10 such as buying the physical object 10.

To provide the services, each external service 50 must register with the RCM directory server 40. The external service 50 may register its service or services with the RCM directory server 40 in any method known in the art or future developed. The RCM directory server 40 will support any registration method by using mediation adaptors. The following registration method described below is provided by way of an example only, to further understanding of the present invention. The following example is not presented by way of a limitation.

The service provider of the external service 50 will submit a registration request that will include the object ID 20 or a number of object IDs with which the service will be associated. The submitted registration request may also include any or all of the following: description of the service, information to be presented to the user (e.g., “buy with X service provider”), and command activation information necessary to execute the external service 50. The service provider may register its external service 50 (description of the service, functions, information, and/or commands provided by the external service 50) using web services technology such as Universal Description, Discovery, and Integration (UDDI) or Web Services Description Language (WSDL).

As new physical objects become available, the service provider may update its registration to include services provided for that new objects or the registration may be updated automatically. For instance, almost every published book uses ISBN registration for cataloging. Accordingly, the service provider may update its registration to include the new book. Similarly, TV sets have serial numbers. These serial numbers may be registered with the warranty database of the manufacturer or the local dealer. The manufacturer's database may be connected with the relevant external service. Accordingly, the relevant external service may automatically update its registration information for each new physical object that is registered in the manufacturer's database. Moreover, the relevant external service may update its registration information for a number of new physical objects in one operation, as described in greater detail below.

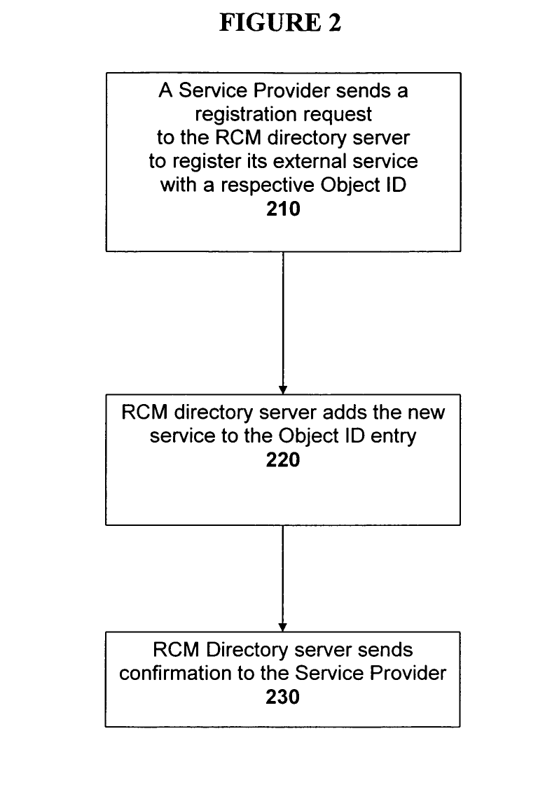

FIG. 2 depicts the registration process for the external services in accordance with an illustrative, non-limiting embodiment of the present invention. At step 210, the service provider sends a registration request to the RCM directory server 40. The registration request includes commands executed by the external service 50 of the service provider, object ID or object IDs, command activation information, and/or additional data such as information to be presented to the user. The RCM directory server adds the new service and its respective commands to the respective object ID entry or to the entries of the respective object IDs at step 220 and sends a confirmation of the registration to the service provider at step 230.

The registration may also indicate that the service will be provided for a set of object IDs. Any method or technique known in the art or future developed for indicating a set of object IDs or a range of object IDs is within the scope of the invention. For example, to facilitate registration for a set of object IDs, wildcards can be used. That is, if the service provider wants to indicate that the service will be provided for a specific product but for any color of that product and if the product's color is identified by the last 3 digits in the catalogue number, then the registration may use a wildcard such as 123-5634-XXX to indicate that the service will be provided to all the products with the prefix beginning with 123-5634 regardless of the last 3 digits (indicated with XXX).

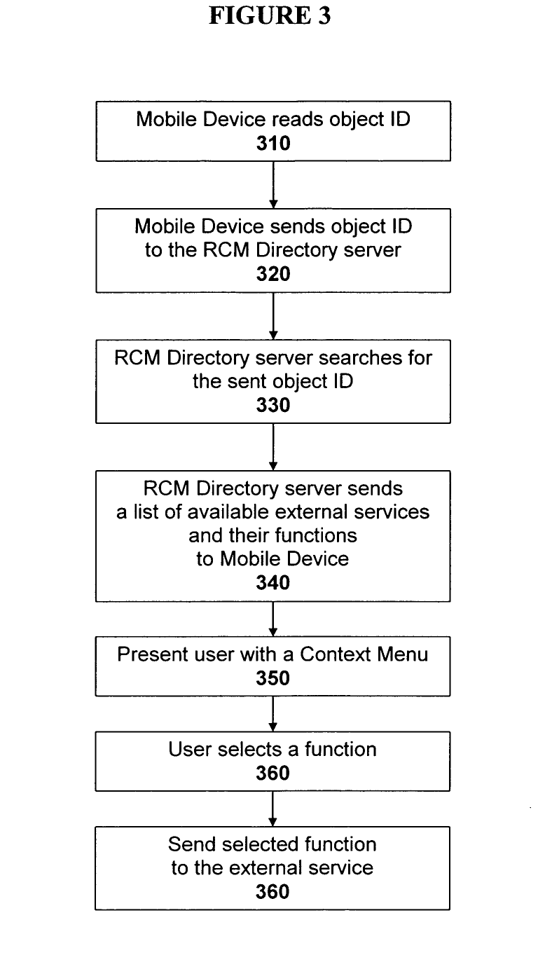

FIG. 3 depicts the process of a user using the RCM services to obtain the desired service. In step 310, the user uses the mobile device to read an object ID of a physical object of interest. The mobile device will read the object ID using any detecting methods available, as described above, including: OCR, Barcode, URL-Code, WiFi, Bluetooth, RFID, Infrared, Microchip, etc. For example, a mobile phone with a camera may take a picture of a tag and then use OCR to interpret the object ID on the tag. A physical object may also have more than one object ID and more than one detection method may be used to detect each and any of the object IDs. For example, each object ID may describe a different feature of the physical object such as the object instance or the object type. In the event that the physical object has two object IDs, the RCM directory server may present a context menu with commands regarding both object IDs, e.g., “get repairing history of this machine” and “get price of a new machine of this type.”

Once the mobile device reads the object ID, the mobile device sends the object ID to the RCM directory server at step 320. That is, the mobile device queries the RCM directory server for external services associated with the object ID. The RCM directory server searches for the object ID provided by the mobile device at step 330. For example, the RCM directory server may have a table that links object IDs with the respective external services. Accordingly, without accessing external services, the RCM directory server may identify each and every external service provided for the identified object ID. The search to identify the services for the identified object ID can be implemented using standard Directory search such as Lightweight Directory Access Protocol (LDAP), Web Services, and so on.

Moreover, after identifying each and every external service provided for this object ID, the RCM directory server may query these identified external services to refresh their offering. For example, if Amazon.com™ was registered for a certain book, then the registration may indicate that when the RCM directory server is building the context menu for this book, it should refresh the command provided by Amazon.com™, i.e., it should query Amazon.com™ for the commands provided with the identified book. As a result, Amazon.com™ will be able to delete the services that do not exist anymore for this identified book or to add real-time data such as delivery time, e.g., “Buy at Amazon, delivery time: 48 hours.” That is, prior to building the context menu based on the external services available for the identified object ID, the RCM directory server may query each external service registered with the identified ID for the commands and information to provide with the identified object ID. Accordingly, the user will be provided with the latest services and information for the selected object.

Once the RCM directory server identifies all of the external services associated with the provided object ID, the RCM directory server replies to a search query of the mobile device with a list of available external services including functions or methods that can be implemented by these external services, as depicted in step 340. The service methods or functions can be commands that will be sent to the external service (directly or via the RCM directory server) or it can be information required for the mobile device to send the command directly to the physical object. The mobile device will use this information to present the user with a Context Menu that may include a list of actions to be executed on the object at step 350.

From the Context Menu, the user selects a function or an action to execute with respect to the physical object at step 360. The selected function or action is sent to the external service directly or via the RCM directory server. The action can be a command for activation such as remote procedure call (RPC), Web Services, etc. Next, the mobile device can switch and work directly with the external service providing the selected function. Later, the user may return back to the Context Menu to implement another action or function, e.g., when the user wants to make a purchase and needs to provide further information. Alternatively, the mobile device can remain in the Context Menu without switching to the external service.

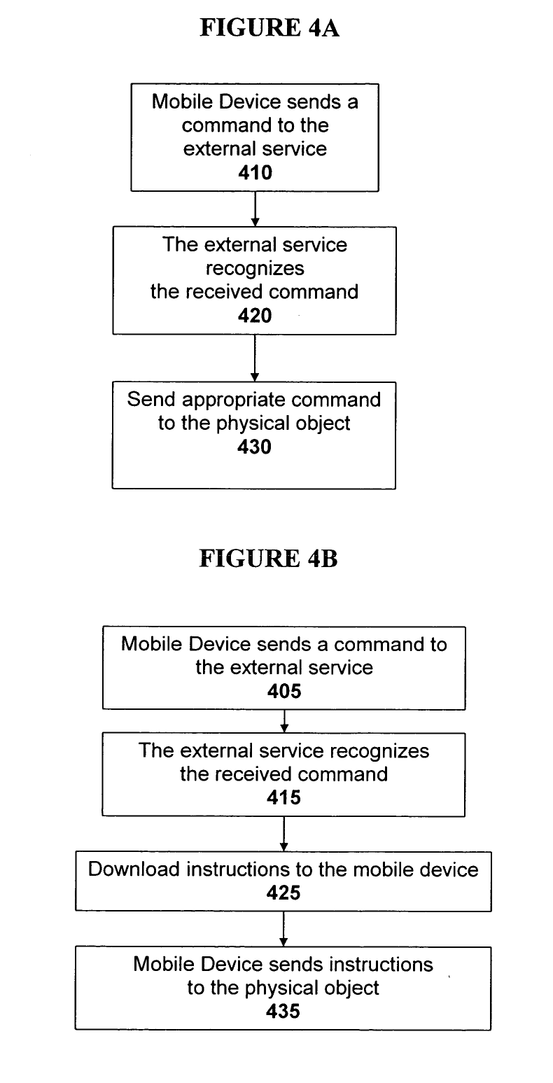

FIG. 4A depicts a process flow when the mobile device remains in the Context Menu without switching to the external service. In this case, the mobile device sends one command at a time. As depicted in FIG. 4A, the mobile device sends the command to be executed to the external service in step 410. This sent command will be executed by the external service, e.g., turn-on the physical object. As previously explained, the function or command can be any type including activating the object, requesting and receiving information regarding the object e.g., the object's manual or list price, or executing a transaction related to the object, e.g., buying the object. To activate the physical object, the external service recognizes the command sent from the mobile device at step 420. Then, the external service sends an appropriate command or a sequence of instructions to the physical object, at step 430, to execute the command requested by the mobile device, i.e., to activate the real-life object from the external service.

On the other hand, the mobile device can activate the physical object directly, i.e., activate the physical object from the mobile device using activation information provided by the respective external service. FIG. 4B illustrates the process of the direct activation from the mobile device. In step 405, the mobile device sends the desired command to the respective external service. In step 415, the external service recognizes the received command. Next, in step 425, the external service provides the mobile device with the necessary instructions or data to implement the selected command. For example, the mobile device downloads the activation sequence to become a remote control to the physical object such as a TV set. The activation sequence may be an Infrared configuration and a command sequence, Bluetooth commands, or any type of remote communication method instructions. The mobile device includes technology necessary to support all of the available communication methods to the physical object such as Infrared and Bluetooth. At step 435, the mobile device sends the downloaded instructions or the activation sequence to the physical object for execution.

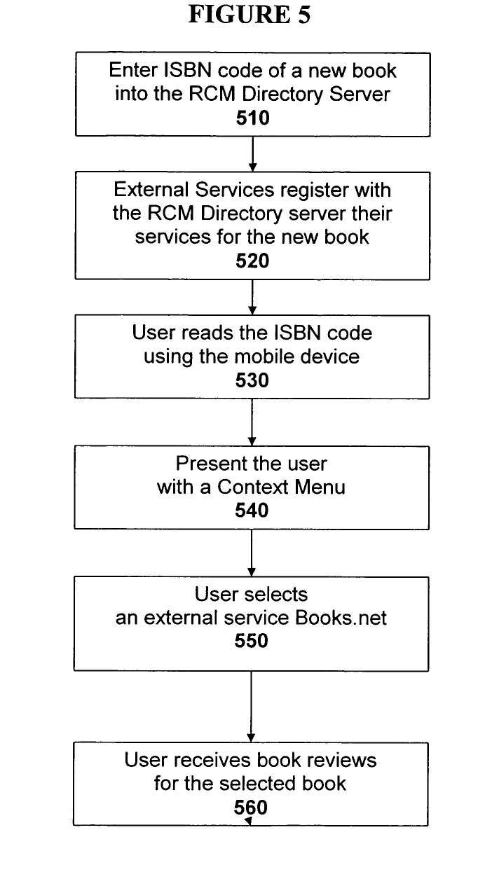

Next, FIG. 5 illustrates an exemplary RCM service with respect to a book. When a new book is published, the book's ISBN code is added to the RCM directory server, as depicted in FIG. 5 at step 510. Although in the example depicted in FIG. 5, the step 510 is implemented, this step 510 may easily be omitted. That is, the ISBN code of a new book may only be registered with an external service that will provide the RCM directory with this ISBN code as an object ID. This step 510, however, may be beneficial as it would allow the RCM directory to check the service provider's registration and verify that it is accurate. For example, if the Motor Vehicle Administration inserts all the license plate numbers to the RCM directory, then if a service provider registers a service per license plate that does not exist, the service provider will receive an error indicator.

Next, at step 520, the external service entities such as AMAZON™, DealTime™, a publisher, reviewers, and others will register to provide service per that object. They will register providing the specific command and the activation method. In particular, the external services will send a registration request that will include the ISBN, the commands associated with this ISBN, and information to be displayed to the user, e.g., names of various services available for this ISBN.

Next, the user in a book store, for example Bames and Nobles™, uses his/her mobile device to read the ISBN code of the new book, at step 530. For example, the user uses an embedded Barcode reader, a camera on his mobile phone, or simply types in the ISBN code. In response, the user receives a Context Menu of available options, at step 540.

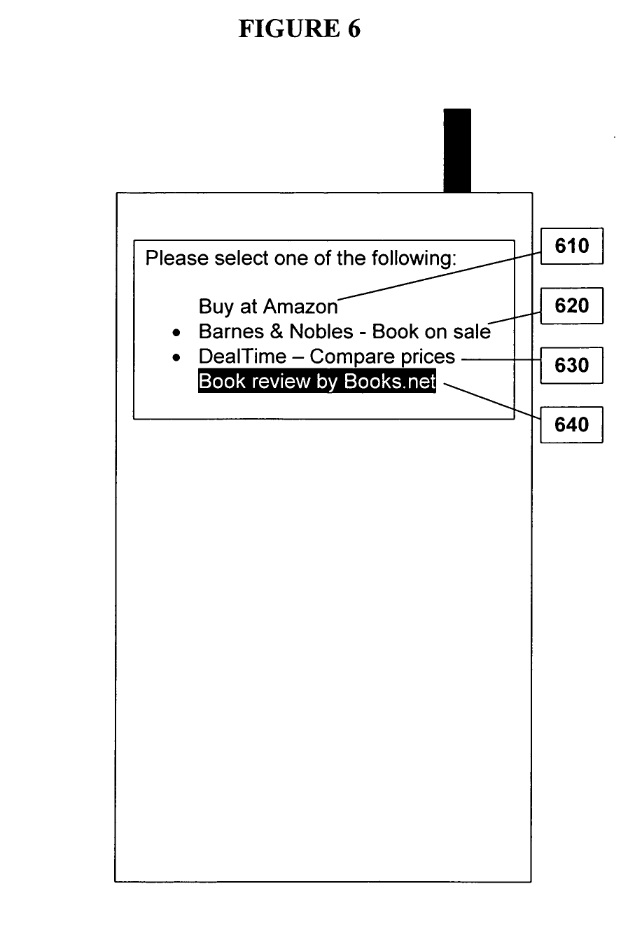

An exemplary Context Menu is depicted in FIG. 6. In particular, as illustrated in FIG. 6, the menu item 610 titled “Buy at Amazon” allows the user to purchase the book. The menu item 620 titled “Bames & Nobles—Book on sale” may provide the user with special member deals for this book. The menu item 630 titled “DealTime—Compare prices” allows the user to compare prices at various stores and internet sites. The menu item 640 titled “Book reviews by Books.net” provides the user with various reviews about the book.

At step 550, the user, for example, selects Book review by Books.net 640, as depicted in FIG. 6. The selection is transmitted to the RCM directory server. The directory server forwards the selection to Books.net, the selected external service. The selected external service then executes the functions necessary to provide the service such as query its database for book reviews with respect to the selected ISBN code.

Alternatively, when the user selects Books.net at step 550, the command or information associated with the selection may be forwarded directly from the mobile device to the external service, i.e., Books.net. That is, along with the context menu, the mobile device is provided with all the necessary information to directly activate the external service without further communication with the RCM directory server. That is, upon selection of the external service, the RCM directory server could provide the mobile device with direct access information. For instance, the direct access information for the mobile device can be provided using web services technology or simple URLs with all the required information. Then, the selected external service provides the user with book reviews for the selected ISBN code at step 560.

The RCM service can also be used in other instances. A service can be provided per specific catalogue, per license plate numbers and so on. For example, the Transportation Authority may contact specific service providers that can provide services based on license plates, such as the police, municipal parking office, and the transportation authority (e.g., motor vehicle administration) itself. The RCM service can also be used internally within an enterprise such as in manufacturing i.e., using dedicated mobile devices with system parts identification.

In the illustrative, non-limiting embodiments of the present invention mentioned above, the RCM service is open to new external service providers. That is, the new external service providers may register with the RCM directory server or the old service providers may update their inventory once a new service or an updated version of the service becomes available. Actions for the physical object may be added on the fly.

In addition, in these exemplary embodiments of the present invention, the end-user may apply any action on the object without knowing upfront the available services. The focus is on the object and not the application. Accordingly, this exemplary system is more intuitive to the end-user. For example, the RCM service may make the mobile device a remote control on-the-fly based on the object ID and without any configuration.

In these exemplary embodiments of the present invention, the end-user is provided with a Context Menu related to the real-life objects. The new RCM service will allow the user of a mobile device to indicate a real-life object (electrical appliances, books, grocery items, exhibition items, etc.) and obtain all of the potential actions related to this object. These will include actions that will activate the object, provide information on the object, from the Internet, for example, or execute a transaction on the Internet related to the object. This generic service can be customized to provide specific services within an industry e.g., field engineering.

The above and other features of the invention including various novel method steps and a system of the various modules have been particularly described with reference to the accompanying drawings and pointed out in the claims. It will be understood that the particular process and construction of parts embodying the present invention is shown by way of illustration only and not as a limitation of the invention. The principles and features of this invention may be employed in varied and numerous embodiments without departing from the spirit and scope of the invention as defined by the appended claims.

What is claimed is:

1. A system providing a user with a plurality of services related to a physical object, the system comprising:
a mobile device detecting the physical object;
a plurality of external service providers, each having at least one service for the physical object; and
a service directory server registering each external server provider to generate a list of available services for the detected physical object and providing the list of available services for the detected physical object to the mobile device.

2. The system according to claim 1, wherein the service directory server generates a real-environment context menu for the detected physical object that lists available services for the detected physical object and providing the generated real-environment context menu to the mobile device.

3. The system according to claim 2, wherein the context menu is dynamically generated for the detected physical object based on the services provided by the registered external services.

4. The system according to claim 1, wherein the physical object has at least one object identifier detected by the mobile device.

5. The system according to claim 4, wherein the object identifier is selected from a group comprising an ISBN number, an IP address, a manufacturer catalog number, a phone number, a license plate number, and an URL.

6. The system according to claim 4, wherein the physical object has a first object identifier indicating a type of the physical object and a second object identifier indicating a specific instance of the physical object, and wherein, based on the selected object identifier, the service directory server offers different services of the registered external service providers to the user via the mobile device.

7. The system according to claim 4, wherein the object identifier indicates one of a type of the physical object and a specific instance of the physical object, and wherein, based on the indication of the object identifier, the service directory server offers different services of the registered external service providers to the user via the mobile device.

8. The system according to claim 1, wherein the mobile device detects the physical object by at least one of optical character recognition, barcode reading, and radio frequency identification.

9. The system according to claim 1, wherein the mobile device is configured to identify the object identifier by manually inputting the object identifier into the mobile device.

10. The system according to claim 1, wherein the list of services comprises at least one action to be performed on the physical object, information relating to the physical object, and a transaction related to the physical object.

11. The system according to claim 10, wherein, when the user selects the activation command via the mobile device, instructions for activation are downloaded into the mobile device and the mobile device directly activates the physical object.

12. The system according to claim 10, wherein, when the user selects the activation command via the mobile device, respective external service provider recognizes user selection and activates the physical object.

13. The system according to claim 1, wherein the physical object is an animal or a human.

14. The system according to claim 1, wherein the physical object comprises at least one of a consumer appliance, a machinery of an automation system or a production line, an industrial equipment, a grocery item, and a consumer goods product.

15. The system according to claim 1, wherein one of the plurality of external service providers is a separate and independent service provider from the remaining external service providers.

16. A method for providing services related to a physical object to a user, the method comprising:
selecting a physical object;
detecting identification of the selected physical object via a mobile device;
querying, based on the detected identification by the mobile device, a directory server for a list of available services for the selected physical object;
searching by the directory server, based on the detected identification, a plurality of external service providers for available services for the selected physical object registered with the directory server;
generating a reality context menu, which lists available services for the physical object found by the directory server; and
providing the generated reality context menu to the user via the mobile device.

17. The method according to claim 16, further comprising:
selecting by the user from the provided reality context menu one of the found available services; and
downloading into the mobile device instructions to execute the selected service.

18. The method according to claim 16, further comprising:
selecting by the user from the provided reality context menu one of the found available services;
transmitting the selected service to the external service provider; and
executing by the external service provider the selected service,
wherein, when the user selects an available service that is an activation command for the selected physical object, respective external service provider recognizes the user selection and activates the selected physical object.

19. The method according to claim 16, further comprising a new external service provider registering with the directory server, wherein the context menu is dynamically generated for each user request based on the services provided by the registered external service providers.

20. The method according to claim 16, wherein the identification of the selected physical object is based on an object identification, where the object identification is one of an ISBN number, an IP address, a manufacturer catalog number, a phone number, a license plate number, and an URL.

21. The method according to claim 20, wherein the physical object has a first object identification indicating a type of the physical object and a second object identification indicating a specific instance of the physical object, and wherein, based on the detected object identification, the directory server offers different services of the registered external service providers to the user via the mobile device.

22. The method according to claim 20, wherein the object identification indicates one of a type of the physical object and a specific instance of the physical object, and wherein, based on the indication of the object identification, the service directory server offers different services of the registered external service providers to the user via the mobile device.

23. The method according to claim 16, wherein the mobile device detects the identification of the selected physical object by at least one of optical character recognition, barcode reading, and radio frequency identification.

24. The method according to claim 16, wherein the mobile device is configured to detect the identification of the selected physical object by manually inputting the object identifier into the mobile device.

25. The method according to claim 16, wherein the available services comprise at least one action to be performed on the physical object, information relating to the physical object, and a transaction related to the physical object.

26. The method according to claim 16, wherein the selected physical object is an animal or a human.

27. The method according to claim 16, wherein the selected physical object comprises at least one of a consumer appliance, a machinery of an automation system or a production line, an industrial equipment, a grocery item, and a consumer goods product.

28. The method according to claim 16, wherein one of the plurality of external service providers is a separate and independent service provider from the remaining external service providers and wherein said one external service provider is separate and independent from the directory server.

29. The method according to claim 16, wherein the generated reality context menu comprises said available services provided by the plurality of external service providers.

30. A method for executing a service by a mobile device for a physical object, the method comprising:
detecting identification of a physical object via the mobile device;
transmitting by the mobile device the identification of the physical object to the directory server;
receiving by the mobile device a reality context menu listing services for the physical object, the services provided by at least two different service providers;
displaying by the mobile device the reality context menu;
receiving by the mobile device a user selection of a service selected from the reality context menu; and
executing by the mobile device the selected service.

31. The method according to claim 30, further comprising:
querying, by the mobile device, a service provider of the selected service for instructions to execute the selected service;
receiving, by the mobile device, from the service provider of the selected service instructions to execute the selected service; and
executing the selected service by the mobile device.

32. The method according to claim 30, further comprising:
querying, by the mobile device, a service directory server that generated the reality context menu for contact information of a service provider of the selected service;
receiving, by the mobile device, from the service directory server the contact information for querying the service provider of the selected service; and
requesting, by the mobile device, the service provider of the selected service to execute the selected service.
